(19) United States
(12) Patent Application Publication
(10) Pub. No.: US 2019/0267609 A1
(43) Pub. Date: Aug. 29, 2019

(54) NEGATIVE ELECTRODE AND LITHIUM ION BATTERY COMPRISING NEGATIVE ELECTRODE

(71) Applicant: Ningde Amperex Technology Limited, Ningde (CN)

(72) Inventors: Yajie Li, Ningde (CN); Changchuan Shi, Ningde (CN); Xinghua Tao, Ningde (CN); Zhanzhao Fang, Ningde (CN); Chao Gao, Ningde (CN)

(21) Appl. No.: 16/282,281

(22) Filed: Feb. 21, 2019

(30) Foreign Application Priority Data
Feb. 26, 2018 (CN) 201810159726.8

(51) Int. Cl. H01M 4/13; H01M 10/0525

(52) U.S. Cl. CPC H01M 4/13; H01M 2004/027; H01M 10/0525

(57) ABSTRACT

An embodiment of the present application provides a negative electrode and a lithium ion battery including the negative electrode, the negative electrode includes a negative electrode current collector, and a negative electrode active material layer arranged on the negative electrode current collector, wherein the negative electrode active material layer includes a negative electrode active material and a dispersant, and the dispersant includes lithium carboxymethylcellulose, wherein the mass ratio of the negative electrode active material to the dispersant being ≥18.74. The present application greatly reduces the DC resistance of the lithium ion battery and the charge transfer resistance at the interface without losing the energy density of the lithium ion battery, without affecting the cycle life of the lithium ion battery or causing cyclic expansion, which avoids the lithium precipitation phenomenon of the lithium ion battery during the cycle of charge and discharge.

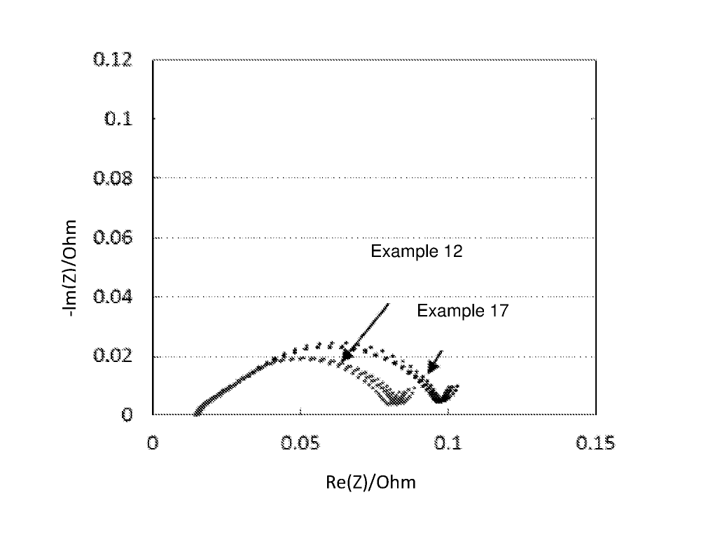

### CROSS-REFERENCE TO RELATED APPLICATION

This application claims priority to and benefits of Chinese Patent Application Serial No. 201810159726.8, filed with the China National Intellectual Property Administration on Feb. 26, 2018, and the entire content of which is incorporated herein by reference.

### FIELD OF THE APPLICATION

The embodiment of the present application relate to the field of battery, in particular, to a negative electrode and a lithium ion battery comprising the negative electrode.

### BACKGROUND OF THE APPLICATION

When a lithium ion battery is being charged rapidly or at a low temperature, if the negative electrode kinetics of the lithium ion battery is insufficient, Li⁺ is enriched in the negative electrode and electrons are obtained on the surface of the negative electrode active material layer to precipitate on the surface of the negative electrode in the form of lithium dendrites, then the formation of lithium dendrites will deteriorate the cycle life of lithium ion battery, as well as cause a risk of piercing the separator, causing a safety hazard.

In order to avoid the phenomenon of lithium precipitation, the following methods are usually used: the first is to reduce the compaction density of the electrode, improve the dynamic performance of the lithium ion battery, improve the rate performance, avoid the lithium precipitation, but this will lose the energy density of the lithium ion battery; the second is to use a nitrile or ester modified negative electrode binder to avoid lithium precipitation, but this will increase the cyclic expansion of the lithium ion battery; the third is to increase the proportion of low-viscosity solvents in the electrolyte and avoid the low-temperature lithium precipitation, but it tends to lower the conductivity of the electrolyte and deteriorate the phenomenon of lithium precipitation at room temperature, and solvents with low viscosity generally have a lower boiling point and may also degrade the high temperature storage performance of lithium ion battery.

Therefore, although the above several methods can avoid the lithium precipitation to varying degrees, they also bring some defects and are not entirely satisfactory.

### SUMMARY OF THE APPLICATION

The present application greatly reduces the DC resistance of the lithium ion battery and the charge transfer resistance at the interface without losing the energy density of the lithium ion battery, without affecting the cycle life of the lithium ion battery and causing cyclic expansion, which avoids the lithium precipitation phenomenon of the lithium ion battery during the cycle of charge and discharge, and provides support for continuing to increase the charge and discharge rate.

The example of the present application provides a negative electrode comprising a negative electrode current collector; a negative electrode active material layer arranged on the negative electrode current collector; wherein the negative electrode active material layer comprises a negative electrode active material and a dispersant, the dispersant comprises lithium carboxymethylcellulose, and the mass ratio of the negative electrode active material to the dispersant is 8.74.

In the above negative electrode, the dispersant comprises a mixture of lithium carboxymethylcellulose and sodium carboxymethylcellulose.

In the above negative electrode, the dispersant has a degree of substitution ranging from 0.6 to 1.3.

In the above negative electrode, the negative electrode active material comprises one or a combination of artificial graphite, natural graphite, silicon carbide, mesophase carbon microbeads, silicon, and alloys thereof.

In the above negative electrode, the negative electrode active material layer further comprises a binder, and the binder is selected from one or a combination of polyvinylidene fluoride, a copolymer of vinylidene fluoride and hexafluoropropylene, a copolymer of styrene and acrylates, a copolymer of styrene and butadiene, polyamide, polyacrylonitrile, polyacrylates, polyacrylic acid, polyacrylate, sodium carboxymethylcellulose, polyvinylpyrrolidone, polyvinyl ether, polymethylmethacrylate, polytetrafluoroethylene and polyhexafluoropropylene.

In the above negative electrode, the negative electrode active material layer further comprises a conductive agent, and the conductive agent comprises one or a combination of conductive carbon, conductive carbon black, lamellar graphite, carbon fiber, carbon nanotube, graphene.

In the above negative electrode, the negative electrode current collector comprises one or a combination of copper foil, nickel foil, and carbon-based current collector.

Examples of the present application also provide a lithium ion battery, comprising a positive electrode, a negative electrode, and an electrolyte, wherein the negative electrode comprises: a negative electrode current collector; a negative electrode active material layer arranged on the negative electrode current collector; wherein the negative electrode active material layer comprises a negative electrode active material and a dispersant, the dispersant comprises lithium carboxymethylcellulose, and the mass ratio of the negative electrode active material to the dispersant is 8.74.

In the above lithium ion battery, the dispersant comprises a mixture of lithium carboxymethylcellulose and sodium carboxymethylcellulose.

In the above lithium ion battery, wherein the dispersant has a degree of substitution ranging from 0.6 to 1.3.

In the above lithium ion battery, the negative electrode active material comprises one or a combination of artificial graphite, natural graphite, silicon carbide, mesophase carbon microbeads, silicon, and alloys thereof.

In the above lithium ion battery, the negative electrode active material layer further comprises a binder, and the binder is selected from one or a combination of polyvinylidene fluoride, a copolymer of vinylidene fluoride and hexafluoropropylene, a copolymer of styrene and acrylates, a copolymer of styrene and butadiene, polyamide, polyacrylonitrile, polyacrylates, polyacrylic acid, polyacrylate, sodium carboxymethylcellulose, polyvinylpyrrolidone, polyvinyl ether, polymethylmethacrylate, polytetrafluoroethylene and polyhexafluoropropylene.

In the above lithium ion battery, the negative electrode active material layer further comprises a conductive agent, and the conductive agent comprises one or a combination of conductive carbon, conductive carbon black, lamellar graphite, carbon fiber, carbon nanotube, graphene.

In the above lithium ion battery, the negative electrode current collector comprises one or a combination of copper foil, nickel foil, and carbon-based current collector.

In the above lithium ion battery, the positive electrode comprises a positive electrode active material, and the positive electrode active material comprises one or a combination of lithium cobalt oxide, lithium manganese oxide, lithium nickel manganese oxide, lithium nickel cobalt manganese oxide, lithium iron phosphate, lithium nickel cobalt aluminate, lithium nickel cobalt oxide, and lithium nickel oxide.

In the above lithium ion battery, the electrolyte comprises a lithium salt and a solvent, and the lithium salt is selected from one or a combination of lithium hexafluorophosphate (LiPF₆), lithium difluorophosphate (LiPO₂F₂), lithium tetrafluoroborate (LiBF₄), lithium hexafluoroarsenate, lithium perchlorate, lithium dioxalate borate (LiBOB), lithium difluorooxalate borate (LiDFOB), lithium bisfluorosulfonimide (LiFSI), lithium bis-trifluoromethane sulfonimide (LiTFSI); the solvent comprises one or a combination selected from ethylene carbonate, propylene carbonate, butylene carbonate, ethyl methyl carbonate, dimethyl carbonate, diethyl carbonate, dipropyl carbonate, methyl propyl carbonate, ethyl propyl carbonate, 1,4-butyrolactone, methyl propionate, methyl butyrate, ethyl acetate, ethyl propionate, ethyl butyrate.

By making the mass ratio of the negative electrode active material and the dispersant in the negative electrode active material layer ≥18.74, selecting the dispersant from lithium carboxymethyl cellulose or a mixture of lithium carboxymethyl cellulose and sodium carboxymethyl cellulose, the present application greatly reduces the DC resistance of the lithium ion battery and the charge transfer resistance at the interface without losing the energy density of the lithium ion battery, without affecting the cycle life of the lithium ion battery and causing cyclic expansion, which avoids the lithium precipitation phenomenon of the lithium ion battery during the cycle of charge and discharge.

### BRIEF DESCRIPTION OF THE ACCOMPANYING DRAWINGS

The FIGURE shows electrochemical impedance spectroscopy (EIS) curves of the negative electrodes of the lithium ion battery of Examples 12 and 17 at 0° C.

### DETAILED DESCRIPTION OF THE PREFERRED EXAMPLES

The following examples are provided to enable those skilled in the art to understand the present application more fully, but do not limit the application in any way.

The negative electrode of the lithium ion battery comprises a negative electrode current collector and a negative electrode active material layer arranged on the negative electrode current collector. The negative electrode is prepared by coating a slurry of the negative electrode active material layer on a negative electrode current collector to dry. The negative electrode current collector may be one or a combination of copper foil, nickel foil, and carbon-based current collector. The negative electrode active material layer may comprise a negative electrode active material and a dispersant. The negative electrode active material may comprise one or a combination of artificial graphite, natural graphite, silicon carbide, and mesophase carbon microbeads. The dispersant may comprise one or a combination of lithium carboxymethylcellulose, and a mixture of lithium carboxymethylcellulose and sodium carboxymethylcellulose, wherein the degree of substitution of sodium carboxymethylcellulose and lithium carboxymethylcellulose may range from 0.6 to 1.3. The degree of substitution refers to the average number of hydroxyl groups substituted by the reagents on each water-loss glucose unit. Too high or low degree of substitution is not favored to the dissolution of carboxymethyl cellulose (CMC) in water. In addition, when the degree of substitution is low, the dispersant shrinks insignificantly on the surface of the graphite during drying, and the degree of kinetics improvement is not obvious. Improving the negative-electrode kinetics performance of lithium ion batteries mainly comprises reducing the DC resistance and charge-transfer resistance of lithium-ion batteries, and avoiding the lithium precipitation of lithium ion batteries during rapid charging and low-temperature charging. In order to improve the negative-electrode kinetics performance of lithium ion batteries, the mass ratio (K) of the negative electrode active material and the dispersant is set to ≥18.74. In the drying process of the negative electrode, the dispersant is coated on the surface of the negative electrode active material to form a membrane; when the content of the negative electrode active material is increased relative to the content of the dispersant, the coating of the surface of the negative electrode active material by the dispersant is reduced, which greatly increases the transmission and intercalation of lithium ions, thereby reducing the risk of lithium precipitation. The mass ratio of the dispersant to the negative electrode active material layer may be 0.5% to 5%; if the amount of the dispersant is too high, the coverage for the negative electrode active material particles will be increased, resulting in a decrease in the negative-electrode kinetics performance of the lithium ion battery; if the amount of the dispersant is too small, the dispersion will be insufficient and the stability of the slurry of the negative electrode active material layer will be affected.

In addition, as a dispersant, lithium carboxymethylcellulose has a higher improvement in the kinetics performance of the negative electrode of a lithium ion battery than sodium carboxymethylcellulose. On the one hand, this is because the lithium on the surface of lithium carboxymethylcellulose is close to the nature of lithium ions in the electrolyte, a lithium ion migration path may be formed on the surface of lithium carboxymethylcellulose, reducing the hindrance of lithium ions in the electrolyte to intercalate in the negative electrode of the lithium ion battery; on the other hand, due to the different preparation processes, the molecular weight of lithium carboxymethyl cellulose is larger than that of sodium carboxymethyl cellulose, and the substitution of lithium in the molecular chain is not uniform, so that the coverage of lithium carboxymethylcellulose on the surface of the negative electrode active material particles is lower than that of sodium carboxymethyl cellulose, which increases the area of the negative electrode of the lithium ion battery intercalated with lithium ions in the electrolyte. Both of these two aspects are beneficial to improve the kinetic performance of the negative electrode of a lithium ion battery, especially low temperature kinetics performance.

Moreover, the negative electrode active material layer may further comprise a binder, and the binder comprises one or a combination of polyvinylidene fluoride, a copolymer of vinylidene fluoride and hexafluoropropylene, a copolymer of styrene and acrylates, a copolymer of styrene and butadiene, polyamide, polyacrylonitrile, polyacrylates, polyacrylic acid, polyacrylate, sodium carboxymethylcellulose, polyvinylpyrrolidone, polyvinyl ether, polymethylmethacrylate, polytetrafluoroethylene and polyhexafluoropropylene. The mass ratio of the binder to the negative electrode active material layer may be 1% to 7%; if the content of the binder is too high, the energy density of the lithium ion battery may be affected; if the content of the binder is too small, the stability of the structure of the negative electrode active material layer is lowered.

Further, the negative electrode active material layer may further comprise a conductive agent for enhancing the conductivity of the negative electrode active material layer. The conductive agent may comprise one or a combination of conductive carbon black, lamellar graphite, carbon nanotube, and graphene.

Examples of the present application also provide a lithium ion battery comprising the above negative electrode. The lithium ion battery comprises a positive electrode, a negative electrode, a separator, and an electrolyte.

The positive electrode comprises a positive electrode current collector and a positive electrode active material layer coated on the positive electrode current collector, and the positive electrode active material layer comprises a positive electrode active material, a conductive agent, and a binder. The positive electrode current collector may employ an Al foil, however, other positive electrode current collectors commonly used in the art may be employed. The conductive agent may comprise one or a combination of conductive carbon black, lamellar graphite, carbon nanotube, and graphene. The binder comprises one or a combination of polyvinylidene fluoride, a copolymer of vinylidene fluoride and hexafluoropropylene, a copolymer of styrene and acrylates, a copolymer of styrene and butadiene, polyamide, a copolymer of styrene and butadiene, polyamide, polyacrylonitrile, polyacrylates, polyacrylic acid, polyacrylate, sodium carboxymethylcellulose, polyvinylpyrrolidone, polyvinylpyrrolidone, polyvinyl ether, polymethylmethacrylate, polytetrafluoroethylene and polyhexafluoropropylene. The positive electrode active material comprises, but is not limited to one or a combination of lithium cobalt oxide, lithium nickel oxide, lithium manganese oxide, lithium nickel manganese oxide, lithium nickel cobalt oxide, lithium iron phosphate, lithium nickel cobalt aluminate, and lithium nickel cobalt manganese oxide; the above positive electrode active material comprises a positive electrode active material which has been doped or coated in the prior art.

Electrolyte

The electrolyte comprises a lithium salt and a non-aqueous solvent. The lithium salt comprises one or a combination selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, LiBOB, LiBr and lithium difluoroborate. For example, the lithium salt is LiPF₆ because it may provide high ionic conductivity and improved cycle characteristics.

The non-aqueous solvent may be one or a combination of a carbonate compound, an ester-based compound, an ether-based compound, a ketone-based compound, an alcohol-based compound, and an aprotic solvent.

The carbonate compound may be one or a combination of a chain carbonate compound, a cyclic carbonate compound, and a fluorocarbonate compound.

Examples of the chain carbonate compound are diethyl carbonate (DEC), dimethyl carbonate (DMC), dipropyl carbonate (DPC), methylpropyl carbonate (MPC), ethyl propyl carbonate (EPC), and methyl ethyl carbonate (MEC) and combinations thereof. Examples of the cyclic carbonate compound are ethylene carbonate (EC), propylene carbonate (PC), butylene carbonate (BC), vinyl ethylene carbonate (VEC), and combinations thereof. Examples of the fluorocarbonate compound are one or a combination of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene carbonate.

Examples of the ester-based compound are one or a combination of methyl acetate, ethyl acetate, n-propyl acetate, t-butyl acetate, methyl propionate, ethyl propionate, γ-butyrolactone, azlactone, valerolactone, mevalonolactone, caprolactone, and methyl formate.

Examples of the ether-based compound are one or a combination of dibutyl ether, tetraglyme, diglyme, 1,2-dimethoxyethane, 1,2-diethoxyethane, ethoxymethoxyethane, 2-methyltetrahydrofuran, and tetrahydrofuran.

An example of the ketone-based compound is cyclohexanone.

Examples of alcohol-based compounds are ethanol and isopropanol.

Examples of aprotic solvent are one or a combination of dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, nitromethane, trimethyl phosphate, triethyl phosphate, trioctyl phosphate and phosphate.

Separator

The separator comprises one or a combination selected from polyethylene, polypropylene, polyethylene terephthalate, polyimide, and aramid. For example, the polyethylene comprises one or a combination selected from high density polyethylene, low density polyethylene, and ultra high molecular weight polyethylene. In particular, polyethylene and polypropylene, which have a good effect on preventing short circuits, and may improve the stability of the lithium ion battery by the shutdown effect.

The separator may further comprise a porous layer arranged on at least one surface of the separator, the porous layer comprising inorganic particles and a binder. The inorganic particle is selected from one or more of alumina (Al₂O₃), silica (SiO₂), magnesia (MgO), titania (TiO₂), hafnium oxide (HfO₂), tin oxide (SnO₂), cerium oxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide and barium sulfate. The binder is selected from one or a combination of polyvinylidene fluoride, a copolymer of vinylidene fluoride-hexafluoropropylene, polyamide, polyacrylonitrile, polyacrylates, polyacrylic acid, polyacrylate, sodium carboxymethylcellulose, polyvinylpyrrolidone, polyvinyl ether, polymethylmethacrylate, polytetrafluoroethylene and polyhexafluoropropylene.

The porous layer on the surface of the separator may improve the heat resistance, oxidation resistance and electrolyte wetting property of the separator, and enhance the adhesion between the separator and the electrode.

The positive electrode, the separator, the negative electrode are sequentially wound or folded into a bare electrode assembly, and then packaged (for example, in an aluminum plastic film) for encapsulation, and injected with an electrolyte for formation and packaging, thus a lithium ion battery is made. Then, the prepared lithium ion battery is subjected to a performance test.

Those skilled in the art will appreciate that the above described methods for preparing the lithium ion battery are merely examples. Other methods commonly used in the art may be employed without departing from the disclosure of the present application.

The negative electrode of the present application may be used in a lithium ion battery of different structures. In the examples, a wound lithium ion battery is taken as an example, but the negative electrode of the present application may be applied to lithium ion batteries of a laminated structure, a multi-tab structure or the like, all of which are comprised within the scope of this application.

The negative electrode of the present application may be used in a lithium ion battery of different types. In the examples, a pouch lithium ion battery is taken as an example, but the negative electrode of the present application may be applied to other lithium ion batteries such as prismatic battery, cylindrical battery, all of which are comprised within the scope of this application.

Some specific examples and comparative examples are listed below to better illustrate the application.

### Comparative Example 1

An aluminum foil is used as a positive electrode current collector, and the surface of the aluminum foil is uniformly coated with a slurry of positive electrode active material layer, which is composed of 97.8 wt % LiCoO₂ (LCO), 0.8 wt % polyvinylidene fluoride (PVDF), and 1.4 wt % conductive carbon black, then drying and cold pressing are performed, to prepare a positive electrode. Among them, the positive electrode active material coating layer has a thickness of 63 μm.

A copper foil is used as a negative electrode current collector, and the surface of the copper foil is uniformly coated with a slurry of negative electrode active material layer, which is composed of 91 wt % artificial graphite, 5 wt % sodium carboxymethyl cellulose, and 4.0 wt % styrene butadiene rubber, then drying and cold pressing are performed, to prepare a negative electrode.

The positive electrode and the negative electrode are wound after being slit, and the positive electrode and the negative electrode are separated by a PE separator, to prepare a wound bare electrode assembly. The bare electrode assembly is subjected to top side sealing, spray code, vacuum drying, electrolyte injection (EC+PC+DEC), high temperature resting, and formation and capacity check, so that a finished lithium ion battery may be obtained.

### Comparative Example 2

The preparation method is the same as that of Comparative Example 1, except that the composition of the slurry of negative electrode active material layer in Comparative Example 2 is a combination of 91 wt % mesophase carbon microbeads, 5 wt % sodium carboxymethylcellulose, and 4.0 wt % styrene butadiene rubber.

### Comparative Example 3

The preparation method is the same as that of Comparative Example 1, except that the composition of the slurry of negative electrode active material layer in Comparative Example 3 is a combination of 91 wt % natural graphite, 5 wt % sodium carboxymethylcellulose, and 4.0 wt % styrene butadiene rubber.

### Comparative Example 4

The preparation method is the same as that of Comparative Example 1, except that the composition of the slurry of negative electrode active material layer in Comparative Example 4 is a combination of 71 wt % artificial graphite, 20% silicon carbide, 5 wt % lithium carboxymethyl cellulose, 3 wt % styrene butadiene rubber and 1% conductive carbon black.

### Comparative Example 5

The preparation method is the same as that of Comparative Example 1, except that the composition of the slurry of negative electrode active material layer in Comparative Example 5 is a combination of 91 wt % silicon carbide, 5 wt % lithium carboxymethyl cellulose, 3 wt % styrene butadiene rubber and 1% conductive carbon black.

### Example 1

The preparation method is the same as that of Comparative Example 1, except that the composition of the slurry of negative electrode active material layer in Example 1 is a combination of 98.2 wt % artificial graphite, 1.3 wt % styrene butadiene rubber, and 0.5 wt % lithium carboxymethyl cellulose.

### Example 2

The preparation method is the same as that of Comparative Example 1, except that the composition of the slurry of negative electrode active material layer in Example 2 is a combination of 98.1 wt % artificial graphite, 1.3 wt % styrene butadiene rubber, and 0.6 wt % lithium carboxymethyl cellulose.

### Example 3

The preparation method is the same as that of Comparative Example 1, except that the composition of the slurry of negative electrode active material layer in Example 3 is a combination of 97.9 wt % artificial graphite, 1.3 wt % styrene butadiene rubber, and 0.8 wt % lithium carboxymethyl cellulose.

### Example 4

The preparation method is the same as that of Comparative Example 1, except that the composition of the slurry of negative electrode active material layer in Example 4 is a combination of 98 wt % artificial graphite, 1 wt % styrene butadiene rubber, and 1 wt % lithium carboxymethyl cellulose.

### Example 5

The preparation method is the same as that of Comparative Example 1, except that the composition of the slurry of negative electrode active material layer in Example 5 is a combination of 97 wt % artificial graphite, 2 wt % styrene butadiene rubber, and 1 wt % lithium carboxymethyl cellulose.

### Example 6

The preparation method is the same as that of Comparative Example 1, except that the composition of the slurry of negative electrode active material layer in Example 6 is a combination of 97.5 wt % artificial graphite, 1.3 wt % styrene butadiene rubber, and 1.2 wt % lithium carboxymethyl cellulose.

### Example 7

The preparation method is the same as that of Comparative Example 1, except that the composition of the slurry of negative electrode active material layer in Example 7 is a combination of 97.2 wt % artificial graphite, 1.3 wt % styrene butadiene rubber, and 1.5 wt % lithium carboxymethyl cellulose.

### Example 8

The preparation method is the same as that of Comparative Example 1, except that the composition of the slurry of negative electrode active material layer in Example 8 is a combination of 96.7 wt % artificial graphite, 1.3 wt % styrene butadiene rubber, and 2 wt % lithium carboxymethyl cellulose.

### Example 9

The preparation method is the same as that of Comparative Example 1, except that the composition of the slurry of negative electrode active material layer in Example 9 is a combination of 94 wt % artificial graphite, 4 wt % styrene butadiene rubber, and 2 wt % lithium carboxymethyl cellulose.

### Example 10

The preparation method is the same as that of Comparative Example 1, except that the composition of the slurry of negative electrode active material layer in Example 10 is a combination of 95.7 wt % artificial graphite, 1.3 wt % styrene butadiene rubber, and 3 wt % lithium carboxymethyl cellulose.

### Example 11

The preparation method is the same as that of Comparative Example 1, except that the composition of the slurry of negative electrode active material layer in Example 11 is a combination of 95 wt % artificial graphite, 2 wt % styrene butadiene rubber, and 3 wt % lithium carboxymethyl cellulose.

### Example 12

The preparation method is the same as that of Comparative Example 1, except that the composition of the slurry of negative electrode active material layer in Example 12 is a combination of 93 wt % artificial graphite, 4 wt % styrene butadiene rubber, and 3 wt % lithium carboxymethyl cellulose.

### Example 13

The preparation method is the same as that of Comparative Example 1, except that the composition of the slurry of negative electrode active material layer in Example 13 is a combination of 90 wt % artificial graphite, 7 wt % styrene butadiene rubber, and 3 wt % lithium carboxymethyl cellulose.

### Example 14

The preparation method is the same as that of Comparative Example 1, except that the composition of the slurry of negative electrode active material layer in Example 14 is a combination of 94.7 wt % artificial graphite, 1.3 wt % styrene butadiene rubber, and 4 wt % lithium carboxymethyl cellulose.

### Example 15

The preparation method is the same as that of Comparative Example 1, except that the composition of the slurry of negative electrode active material layer in Example 15 is a combination of 92 wt % artificial graphite, 2 wt % styrene butadiene rubber, 4 wt % lithium carboxymethyl cellulose and 2 wt % conductive carbon black.

### Example 16

The preparation method is the same as that of Comparative Example 1, except that the composition of the slurry of negative electrode active material layer in Example 16 is a combination of 93.7 wt % artificial graphite, 1.3 wt % styrene butadiene rubber, and 5 wt % lithium carboxymethyl cellulose.

### Example 17

The preparation method is the same as that of Comparative Example 1, except that the composition of the slurry of negative electrode active material layer in Example 17 is a combination of 93 wt % artificial graphite, 4 wt % styrene butadiene rubber, and 3 wt % sodium carboxymethyl cellulose.

### Example 18

The preparation method is the same as that of Comparative Example 1, except that the composition of the slurry of negative electrode active material layer in Example 18 is a combination of 93 wt % artificial graphite, 4 wt % styrene butadiene rubber, 2 wt % lithium carboxymethyl cellulose and 1 wt % sodium carboxymethyl cellulose.

### Example 19

The preparation method is the same as that of Comparative Example 1, except that the composition of the slurry of negative electrode active material layer in Example 19 is a combination of 93 wt % artificial graphite, 4 wt % styrene rubber, and 3 wt % lithium carboxymethyl cellulose.

### Example 20

The preparation method is the same as that of Comparative Example 1, except that the composition of the slurry of negative electrode active material layer in Example 20 is a combination of 93 wt % artificial graphite, 4 wt % phenyl acrylamide, and 3 wt % lithium carboxymethyl cellulose.

### Example 21

The preparation method is the same as that of Comparative Example 1, except that the composition of the slurry of negative electrode active material layer in Example 21 is a combination of 93 wt % artificial graphite, 4 wt % polyacrylamide, and 3 wt % lithium carboxymethyl cellulose.

### Example 22

The preparation method is the same as that of Comparative Example 1, except that the composition of the slurry of negative electrode active material layer in Example 22 is a combination of 93 wt % artificial graphite, 4 wt % polyacrylic acid, and 3 wt % lithium carboxymethyl cellulose.

### Example 23

The preparation method is the same as that of Comparative Example 1, except that the composition of the slurry of negative electrode active material layer in Example 23 is a combination of 93 wt % artificial graphite, 4 wt % polyacrylonitrile, and 3 wt % lithium carboxymethyl cellulose.

### Example 24

The preparation method is the same as that of Comparative Example 1, except that the composition of the slurry of negative electrode active material layer in Example 24 is a combination of 93 wt % artificial graphite, 3 wt % styrene butadiene rubber, 3 wt % lithium carboxymethyl cellulose and 1 wt % conductive carbon black.

### Example 25

The preparation method is the same as that of Comparative Example 1, except that the composition of the slurry of negative electrode active material layer in Example 25 is a combination of 93 wt % artificial graphite, 3 wt % styrene butadiene rubber, 3 wt % lithium carboxymethyl cellulose and 1 wt % lamellar graphite.

### Example 26

The preparation method is the same as that of Comparative Example 1, except that the composition of the slurry of negative electrode active material layer in Example 26 is a combination of 93 wt % artificial graphite, 3 wt % styrene butadiene rubber, 3 wt % lithium carboxymethyl cellulose and 1 wt % carbon nanotube.

### Example 27

The preparation method is the same as that of Comparative Example 1, except that the composition of the slurry of negative electrode active material layer in Example 27 is a combination of 93 wt % artificial graphite, 3 wt % styrene butadiene rubber, 3 wt % lithium carboxymethyl cellulose and 1 wt % graphene.

### Example 28

The preparation method is the same as that of Comparative Example 1, except that the composition of the slurry of negative electrode active material layer in Example 28 is a combination of 93 wt % mesophase carbon microspheres, 4 wt % styrene butadiene rubber, and 3 wt % lithium carboxymethyl cellulose.

### Example 29

The preparation method is the same as that of Comparative Example 1, except that the composition of the slurry of negative electrode active material layer in Example 29 is a combination of 93 wt % natural graphite, 4 wt % styrene butadiene rubber, and 3 wt % lithium carboxymethyl cellulose.

### Example 30

The preparation method is the same as that of Comparative Example 1, except that the composition of the slurry of negative electrode active material layer in Example 30 is a combination of 73 wt % artificial graphite, 20 wt % silicon carbide, 3 wt % styrene butadiene rubber, 3 wt % lithium carboxymethyl cellulose and 1 wt % conductive carbon black.

### Example 31

The preparation method is the same as that of Comparative Example 1, except that the composition of the slurry of negative electrode active material layer in Example 31 is a combination of 93 wt % silicon carbide, 3 wt % styrene butadiene rubber, 3 wt % lithium carboxymethyl cellulose and 1 wt % conductive carbon black.

### Example 32

The preparation method is the same as that of Comparative Example 1, except that the composition of the slurry of negative electrode active material layer in Example 32 is a combination of 93 wt % artificial graphite, 4 wt % styrene butadiene rubber, and 3 wt % lithium carboxymethyl cellulose. The composition of the slurry of positive electrode active material layer is 97.8 wt % lithium manganese oxide, 0.8 wt % polyvinylidene fluoride (PVDF), and 1.4 wt % conductive carbon black.

### Example 33

The preparation method is the same as that of Comparative Example 1, except that the composition of the slurry of negative electrode active material layer in Example 33 is a combination of 93 wt % artificial graphite, 4 wt % styrene butadiene rubber, and 3 wt % lithium carboxymethyl cellulose. The composition of the slurry of positive electrode active material layer is 97.8 wt % lithium nickel manganese oxide, 0.8 wt % polyvinylidene fluoride (PVDF), and 1.4 wt % conductive carbon black.

### Example 34

The preparation method is the same as that of Comparative Example 1, except that the composition of the slurry of negative electrode active material layer in Example 34 is a combination of 93 wt % artificial graphite, 4 wt % styrene butadiene rubber, and 3 wt % lithium carboxymethyl cellulose. The composition of the slurry of positive electrode active material layer is 97.8 wt % lithium nickel cobalt manganese oxide, 0.8 wt % polyvinylidene fluoride (PVDF), and 1.4 wt % conductive carbon black.

### Example 35

The preparation method is the same as that of Comparative Example 1, except that the composition of the slurry of negative electrode active material layer in Example 35 is a combination of 93 wt % artificial graphite, 4 wt % styrene butadiene rubber, and 3 wt % lithium carboxymethyl cellulose. The electrolyte employs EC+PC+DEC+EP.

### Example 36

The preparation method is the same as that of Comparative Example 1, except that the composition of the slurry of negative electrode active material layer in Example 36 is a combination of 93 wt % artificial graphite, 4 wt % styrene butadiene rubber, and 3 wt % lithium carboxymethyl cellulose. The electrolyte employs EC+PC+FEC.

### Example 37

The preparation method is the same as that of Comparative Example 1, except that the composition of the slurry of negative electrode active material layer in Example 37 is a combination of 93 wt % artificial graphite, 4 wt % styrene butadiene rubber, and 3 wt % lithium carboxymethyl cellulose. The electrolyte employs EC+PC.

### Example 38

The preparation method is the same as that of Comparative Example 1, except that the composition of the slurry of negative electrode active material layer in Example 38 is a combination of 93 wt % artificial graphite, 4 wt % styrene butadiene rubber, and 3 wt % lithium carboxymethyl cellulose. The electrolyte employs EC+PC+VC.

### Example 39

The preparation method is the same as that of Comparative Example 1, except that the composition of the slurry of negative electrode active material layer in Example 39 is a combination of 93 wt % artificial graphite, 4 wt % styrene butadiene rubber, and 3 wt % lithium carboxymethyl cellulose. The electrolyte employs DMC+EC.

### Example 40

The preparation method is the same as that of Comparative Example 1, except that the composition of the slurry of negative electrode active material layer in Example 40 is a combination of 93 wt % artificial graphite, 4 wt % styrene butadiene rubber, and 3 wt % lithium carboxymethyl cellulose. The electrolyte employs EMC+DEC.

Next, the corresponding performance test of the prepared lithium ion battery is performed. The test methods and conditions are as follows:

1) The charge transfer resistance Rct is tested by electrochemical impedance spectroscopy (EIS), a lithium-plated copper sheet is inserted between the positive and negative electrodes of the electrode assembly to form a three-electrode system, then the EIS curve of the negative electrode of the electrode assembly is measured at 10⁵-10⁻² Hz using a CHI660 electrochemical workstation at a test temperature of 25° C.

2) The DC resistance DCR is measured by a discharge method, and the electrode assembly with a voltage of 3.85V is discharged with 0.1 C (current is I₁) for 10 s for recording a voltage V1, then discharged with 1 C (current is I₂) for 0.2 s for recording a voltage V2, DCR=(V1−V2)/(I₂−I₁).

3) Test for lithium precipitation: the electrode assembly is charged and discharged with 1.5 C for 10 cycles, and the test temperature is 12° C.; the electrode assembly is disassembled to observe the lithium precipitation of the negative electrode; after observing the surface of the electrode, If there is grayish white lithium dendrite, it means that lithium is precipitated; if the surface of the electrode is golden yellow, it means no lithium precipitation.

The experimental parameters and measurement results of the respective examples and comparative examples are shown in Table 1 below.

TABLE 1

| | negative | positive | | | 25° C. | 25° C. | lithium |
|---|---|---|---|---|---|---|---|
| | electrode | electrode | | | 50%SOC | Rct/ | precipitation |
| | formula | material | Electrolyte | K | DCR/mΩ | mΩ | at 12° C. |
| Example 1 | 98.2% artificial | lithium | EC + PC + | 196.4 | 45 | 10.1 | no lithium |
| | graphite + 1.3% | cobalt | DEC | | | | precipitation |
| | styrene butadiene | oxide | | | | | |
| | rubber + 0.5% | | | | | | |
| | lithium | | | | | | |
| | carboxymethyl | | | | | | |
| | cellulose | | | | | | |
| Example 2 | 98.1% artificial | lithium | EC + PC + | 163.5 | 45.7 | 11.4 | no lithium |
| | graphite + 1.3% | cobalt | DEC | | | | precipitation |
| | styrene butadiene | oxide | | | | | |
| | rubber + 0.6% | | | | | | |
| | lithium | | | | | | |
| | carboxymethyl | | | | | | |
| | cellulose | | | | | | |
| Example 3 | 97.9% artificial | lithium | EC + PC + | 122.375 | 46.6 | 12 | no lithium |
| | graphite + 1.3% | cobalt | DEC | | | | precipitation |
| | styrene butadiene | oxide | | | | | |
| | rubber + 0.8% | | | | | | |
| | lithium | | | | | | |
| | carboxymethyl | | | | | | |
| | cellulose | | | | | | |
| Example 4 | 98% artificial | lithium | EC + PC + | 98 | 46.9 | 12.2 | no lithium |
| | graphite + 1% | cobalt | DEC | | | | precipitation |
| | styrene butadiene | oxide | | | | | |
| | rubber + 1% | | | | | | |
| | lithium | | | | | | |
| | carboxymethyl | | | | | | |
| | cellulose | | | | | | |
| Example 5 | 97% artificial | lithium | EC + PC + | 97 | 49.2 | 13.3 | no lithium |
| | graphite + 2% | cobalt | DEC | | | | precipitation |
| | styrene butadiene | oxide | | | | | |
| | rubber + 1% | | | | | | |
| | lithium | | | | | | |
| | carboxymethyl | | | | | | |
| | cellulose | | | | | | |
| Example 6 | 97.5% artificial | lithium | EC + PC + | 81.25 | 49.2 | 13.3 | no lithium |
| | graphite + 1.3% | cobalt | DEC | | | | precipitation |
| | styrene butadiene | oxide | | | | | |
| | rubber + 1.2% | | | | | | |
| | lithium | | | | | | |
| | carboxymethyl | | | | | | |
| | cellulose | | | | | | |
| Example 7 | 97.2% artificial | lithium | EC + PC + | 64.8 | 52.1 | 14.1 | no lithium |
| | graphite + 1.3% | cobalt | DEC | | | | precipitation |
| | styrene butadiene | oxide | | | | | |
| | rubber + 1.5% | | | | | | |
| | lithium | | | | | | |
| | carboxymethyl | | | | | | |
| | cellulose | | | | | | |
| Example 8 | 96.7% artificial | Lithium | EC + PC + | 48.35 | 53.6 | 14.9 | no lithium |
| | graphite + 1.3% | cobalt | DEC | | | | precipitation |
| | styrene butadiene | oxide | | | | | |
| | rubber + 2% | | | | | | |
| | lithium | | | | | | |
| | carboxymethyl | | | | | | |
| | cellulose | | | | | | |
| Example 9 | 94% artificial | lithium | EC + PC + | 47 | 52.6 | 14.2 | no lithium |
| | graphite + 4% | cobalt | DEC | | | | precipitation |
| | styrene butadiene | oxide | | | | | |
| | rubber + 2% | | | | | | |
| | lithium | | | | | | |
| | carboxymethyl | | | | | | |
| | cellulose | | | | | | |
| Example 10 | 95.7% artificial | lithium | EC + PC + | 31.9 | 55.5 | 15.9 | no lithium |
| | graphite + 1.3% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 11 | 95% artificial | lithium | EC + PC + | 31.667 | 54.5 | 15.3 | no lithium |
| | graphite + 2% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 12 | 93% artificial | lithium | EC + PC + | 31 | 53.5 | 14.9 | no lithium |
| | graphite + 4% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 13 | 90% artificial | lithium | EC + PC + | 30 | 53.2 | 14.8 | no lithium |
| | graphite + 7% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 14 | 94.7% artificial | lithium | EC + PC + | 23.675 | 57.1 | 17.4 | no lithium |
| | graphite + 1.3% | cobalt | DEC | | | | precipitation |
| | styrene butadiene | oxide | | | | | |
| | rubber + 4% | | | | | | |
| | lithium | | | | | | |
| | carboxymethyl | | | | | | |
| | cellulose | | | | | | |
| Example 15 | 92% artificial | lithium | EC + PC + | 23 | 56.4 | 17.1 | no lithium |
| | graphite + 2% | cobalt | DEC | | | | precipitation |
| | styrene butadiene | oxide | | | | | |
| | rubber + 4% | | | | | | |
| | lithium | | | | | | |
| | carboxymethyl | | | | | | |
| | cellulose + 2% | | | | | | |
| | conductive | | | | | | |
| | graphite | | | | | | |
| Example 16 | 93.7% artificial | lithium | EC + PC + | 18.74 | 63.2 | 18.9 | no lithium |
| | graphite + 1.3% | cobalt | DEC | | | | precipitation |
| | styrene butadiene | oxide | | | | | |
| | rubber + 5% | | | | | | |
| | lithium | | | | | | |
| | carboxymethyl | | | | | | |
| | cellulose | | | | | | |
| Example 17 | 93% artificial | lithium | EC + PC + | 31 | 54.1 | 15.2 | no lithium |
| | graphite + 4% | cobalt | DEC | | | | precipitation |
| | styrene butadiene | oxide | | | | | |
| | rubber + 3% | | | | | | |
| | sodium | | | | | | |
| | carboxymethyl | | | | | | |
| | cellulose | | | | | | |
| Example 18 | 93% artificial | lithium | EC + PC + | 31 | 53.8 | 15.1 | no lithium |
| | graphite + 4% | cobalt | DEC | | | | precipitation |
| | styrene butadiene | oxide | | | | | |
| | rubber + 2% | | | | | | |
| | lithium | | | | | | |
| | carboxymethyl | | | | | | |
| | cellulose + 1% | | | | | | |
| | sodium | | | | | | |
| | carboxymethyl | | | | | | |
| | cellulose | | | | | | |
| Example 19 | 93% artificial | lithium | EC + PC + | 31 | 53.3 | 14.8 | no lithium |
| | graphite + 4% | cobalt | DEC | | | | precipitation |
| | styrene rubber + | oxide | | | | | |
| | 3% lithium | | | | | | |
| | carboxymethyl | | | | | | |
| | cellulose | | | | | | |
| Example 20 | 93% artificial | lithium | EC + PC + | 31 | 53.4 | 14.9 | no lithium |
| | graphite + 4% | cobalt | DEC | | | | precipitation |
| | polyacrylate + | oxide | | | | | |
| | 3% lithium | | | | | | |
| | carboxymethyl | | | | | | |
| | cellulose | | | | | | |
| Example 21 | 93% artificial | lithium | EC + PC + | 31 | 53.4 | 15 | no lithium |
| | graphite + 4% | cobalt | DEC | | | | precipitation |
| | polyacrylamide + | oxide | | | | | |
| | 3% lithium | | | | | | |
| | carboxymethyl | | | | | | |
| | cellulose | | | | | | |
| Example 22 | 93% artificial | lithium | EC + PC + | 31 | 53.5 | 14.8 | no lithium |
| | graphite + 4% | cobalt | DEC | | | | precipitation |
| | polyacrylic | oxide | | | | | |
| | acid + 3% | | | | | | |
| | lithium | | | | | | |
| | carboxymethyl | | | | | | |
| | cellulose | | | | | | |
| Example 23 | 93% artificial | lithium | EC + PC + | 31 | 53.2 | 14.7 | no lithium |
| | graphite + 4% | cobalt | DEC | | | | precipitation |
| | polyacrylonitrile + | oxide | | | | | |
| | 3% lithium | | | | | | |
| | carboxymethyl | | | | | | |
| | cellulose | | | | | | |
| Example 24 | 93% artificial | lithium | EC + PC + | 31 | 53.1 | 14.7 | no lithium |
| | graphite + 3% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose + 1% | | | | | | |
| | conductive | | | | | | |
| | carbon black | | | | | | |
| Example 25 | 93% artificial | lithium | EC + PC + | 31 | 53.1 | 14.8 | no lithium |
| | graphite + 3% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose + 1% | | | | | | |
| | lamellar | | | | | | |
| | graphite | | | | | | |
| Example 26 | 93% artificial | lithium | EC + PC + | 31 | 53 | 14.5 | no lithium |
| | graphite + 3% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose + 1% | | | | | | |
| | carbon | | | | | | |
| | nanotube | | | | | | |
| Example 27 | 93% artificial | lithium | EC + PC + | 31 | 53.1 | 14.6 | no lithium |
| | graphite + 3% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose + 1% | | | | | | |
| | graphene | | | | | | |
| Example 28 | 93% | lithium | EC + PC + | 31 | 53.5 | 14.9 | no lithium |
| | mesophase | cobalt | DEC | | | | precipitation |
| | carbon | oxide | | | | | |
| | microspheres + 4% | | | | | | |
| | styrene butadiene | | | | | | |
| | rubber + 3% | | | | | | |
| | lithium | | | | | | |
| | carboxymethyl | | | | | | |
| | cellulose | | | | | | |
| Example 29 | 93% natural | lithium | EC + PC + | 31 | 58.9 | 16 | no lithium |
| | graphite + 4% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 30 | 73% artificial | Lithium | EC + PC + | 31 | 53 | 14.5 | no lithium |
| | graphite + | cobalt | DEC | | | | precipitation |
| | 20% silicon | oxide | | | | | |
| | carbide + 3% | | | | | | |
| | styrene butadiene | | | | | | |
| | rubber + 3% | | | | | | |
| | lithium | | | | | | |
| | carboxymethyl | | | | | | |
| | cellulose + 1% | | | | | | |
| | conductive | | | | | | |
| | carbon black | | | | | | |
| Example 31 | 93% silicon | lithium | EC + PC + | 31 | 52 | 14.4 | no lithium |
| | carbide + 3% | cobalt | DEC | | | | precipitation |
| | styrene butadiene | oxide | | | | | |
| | rubber + 3% | | | | | | |
| | lithium | | | | | | |
| | carboxymethyl | | | | | | |
| | cellulose + 1% | | | | | | |
| | conductive | | | | | | |
| | carbon black | | | | | | |
| Example 32 | 93% artificial | lithium | EC + PC + | 31 | 57.1 | 15.7 | no lithium |
| | graphite + 4% | manganese | DEC | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 33 | 93% artificial | Lithium | EC + PC + | 31 | 55.7 | 15.3 | no lithium |
| | graphite + 4% | nickel | DEC | | | | precipitation |
| | styrene butadiene | manganese | | | | | |
| | rubber + 3% | oxide | | | | | |
| | lithium | | | | | | |
| | carboxymethyl | | | | | | |
| | cellulose | | | | | | |
| Example 34 | 93% artificial | lithium | EC + PC + | 31 | 54.8 | 15.2 | no lithium |
| | graphite + 4% | nickel | DEC | | | | precipitation |
| | styrene butadiene | cobalt | | | | | |
| | rubber + 3% | manganese | | | | | |
| | lithium | oxide | | | | | |
| | carboxymethyl | | | | | | |
| | cellulose | | | | | | |
| Example 35 | 93% artificial | lithium | EC + PC + | 31 | 53.1 | 14.6 | no lithium |
| | graphite + 4% | cobalt | DEC + EP | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 36 | 93% artificial | lithium | EC + PC + | 31 | 53.7 | 15.1 | no lithium |
| | graphite + 4% | cobalt | FEC | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 37 | 93% artificial | lithium | EC + PC | 31 | 53.8 | 15.2 | no lithium |
| | graphite + 4% | cobalt | | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 38 | 93% artificial | lithium | EC + PC + | 31 | 53.7 | 15.1 | no lithium |
| | graphite + 4% | cobalt | VC | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 39 | 93% artificial | lithium | DMC + EC | 31 | 53.7 | 15.1 | no lithium |
| | graphite + 4% | cobalt | | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Example 40 | 93% artificial | lithium | EMC + DEC | 31 | 53.7 | 15.1 | no lithium |
| | graphite + 4% | cobalt | | | | | precipitation |
| | styrene butadiene | oxide | | | | | |
| | rubber + 3% | | | | | | |
| | lithium | | | | | | |
| | carboxymethyl | | | | | | |
| | cellulose | | | | | | |
| Comparative | 91% artificial | lithium | EC + PC + | 18.2 | 86.2 | 36.4 | lithium |
| Example 1 | graphite + 4% | cobalt | DEC | | | | precipitation |
| | styrene butadiene | oxide | | | | | |
| | rubber + 5% | | | | | | |
| | sodium | | | | | | |
| | carboxymethyl | | | | | | |
| | cellulose | | | | | | |
| Comparative | 91% | lithium | EC + PC + | 18.2 | 86.2 | 36.3 | lithium |
| Example 2 | mesophase | cobalt | DEC | | | | precipitation |
| | carbon | oxide | | | | | |
| | microspheres + 4% | | | | | | |
| | styrene butadiene | | | | | | |
| | rubber + 5% | | | | | | |
| | sodium | | | | | | |
| | carboxymethyl | | | | | | |
| | cellulose | | | | | | |
| Comparative | 91% natural | lithium | EC + PC + | 18.2 | 92.7 | 38 | lithium |
| Example 3 | graphite + 4% | cobalt | DEC | | | | precipitation |
| | styrene butadiene | oxide | | | | | |
| | rubber + 5% | | | | | | |
| | sodium | | | | | | |
| | carboxymethyl | | | | | | |
| | cellulose | | | | | | |
| Comparative | 71% artificial | lithium | EC + PC + | 18.2 | 81.7 | 35 | lithium |
| Example 4 | graphite + | cobalt | DEC | | | | precipitation |
| | 20% silicon | oxide | | | | | |
| | carbide + 3% | | | | | | |
| | styrene butadiene | | | | | | |
| | rubber + 5% | | | | | | |
| | lithium | | | | | | |
| | carboxymethyl | | | | | | |
| | cellulose + 1% | | | | | | |
| | conductive | | | | | | |
| | carbon black | | | | | | |
| Comparative | 91% silicon | lithium | EC + PC + | 18.2 | 79.9 | 33.4 | lithium |
| Example 5 | carbide + 3% | cobalt | DEC | | | | precipitation |
| | styrene butadiene | oxide | | | | | |
| | rubber + 5% | | | | | | |
| | lithium | | | | | | |
| | carboxymethyl | | | | | | |
| | cellulose + 1% | | | | | | |
| | conductive | | | | | | |
| | carbon black | | | | | | |

By comparing Examples 1-40 with Comparative Examples 1-5, when the mass ratio (K) of the negative electrode active material and the dispersant is 18.2, the lithium ion battery has a high DC resistance and charge transfer resistance while lithium precipitation occurring. When K≥18.74, the DC resistance and charge transfer resistance of the lithium ion battery are significantly reduced, and no lithium precipitation occurs.

By comparing Examples 1-16, as the mass ratio (K) of the negative electrode active material and the dispersant increases, the DC resistance and charge transfer resistance of the lithium ion battery tend to decrease.

By comparing Examples 17, 18 and 12, when the dispersant is all lithium carboxymethylcellulose (Example 12), the improvement of the DC resistance and charge transfer resistance of the lithium ion battery is superior to the case where the dispersant is a mixture of sodium carboxymethylcellulose and lithium carboxymethylcellulose (Example 18). In addition, when the dispersant is a mixture of sodium carboxymethylcellulose and lithium carboxymethylcellulose, the improvement of DC resistance and charge transfer resistance of the lithium ion battery is superior to the case where the dispersant is all sodium carboxymethylcellulose (Example 17). If the dispersant is a mixture of sodium carboxymethylcellulose and lithium carboxymethylcellulose, the improvement of DC resistance and charge transfer resistance is correspondingly reduced as the proportion of sodium carboxymethylcellulose increases. The FIGURE shows electrochemical impedance spectroscopy (EIS) curves of the negative electrodes of the lithium ion battery of Examples 12 and 17 at 0° C. As shown in the FIGURE, when the dispersant in the negative electrode active material layer is lithium carboxymethyl cellulose, the impedance value is significantly smaller as compared with the same amount of sodium carboxymethyl cellulose, indicating that there is less obstruction for lithium ions to intercalate in the negative electrode, and the lithium ion battery has better kinetic performance.

By comparing Examples 19-23 and 12, it is known that the difference in the kind of the binder may not significantly affect the extent of improvement in the DC resistance and the charge transfer resistance of the lithium ion battery.

By comparing Examples 24-27, it is known that addition and types of conductive agent in the negative electrode active material layer may also not significantly affect the extent of improvement in the DC resistance and the charge transfer resistance of the lithium ion battery.

By comparing Examples 28-31, it is known that difference in the type of negative electrode active material may not significantly affect the extent of improvement in the DC resistance and the charge transfer resistance of the lithium ion battery.

By comparing Examples 32-34 and 12, it is known that difference in positive electrode active material may not significantly affect the extent of improvement in the DC resistance and the charge transfer resistance of the lithium ion battery.

By comparing Examples 35-40 and 12, it is known that difference in electrolyte may not significantly affect the extent of improvement in the DC resistance and the charge transfer resistance of the lithium ion battery.

What is claimed is:

1. A negative electrode, comprising:
a negative electrode current collector;
a negative electrode active material layer arranged on the negative electrode current collector;
wherein the negative electrode active material layer comprises a negative electrode active material and a dispersant, the dispersant comprises lithium carboxymethylcellulose, and the mass ratio of the negative electrode active material to the dispersant is 8.74.

2. The negative electrode according to claim 1, wherein the dispersant comprises a mixture of lithium carboxymethylcellulose and sodium carboxymethylcellulose.

3. The negative electrode according to claim 1, wherein the dispersant has a degree of substitution ranging from 0.6 to 1.3.

4. The negative electrode according to claim 1, wherein the negative electrode active material comprises one or a combination of artificial graphite, natural graphite, silicon carbide, mesophase carbon microbeads, silicon, and alloys thereof.

5. The negative electrode according to claim 1, wherein the negative electrode active material layer further comprises a binder, and the binder is selected from one or a combination of polyvinylidene fluoride, a copolymer of vinylidene fluoride and hexafluoropropylene, a copolymer of styrene and acrylates, a copolymer of styrene and butadiene, polyamide, polyacrylonitrile, polyacrylates, polyacrylic acid, polyacrylate, sodium carboxymethylcellulose, polyvinylpyrrolidone, polyvinyl ether, polymethylmethacrylate, polytetrafluoroethylene and polyhexafluoropropylene.

6. The negative electrode according to claim 1, wherein the negative electrode active material layer further comprises a conductive agent, and the conductive agent comprises one or a combination of conductive carbon, conductive carbon black, lamellar graphite, carbon fiber, carbon nanotube, graphene.

7. The negative electrode according to claim 1, wherein the negative electrode current collector comprises one or a combination of copper foil, nickel foil, and carbon-based current collector.

8. A lithium ion battery, comprising a positive electrode, a negative electrode, and an electrolyte, wherein the negative electrode comprises:
a negative electrode current collector;
a negative electrode active material layer arranged on the negative electrode current collector;
wherein the negative electrode active material layer comprises a negative electrode active material and a dispersant, the dispersant comprises lithium carboxymethylcellulose, and the mass ratio of the negative electrode active material to the dispersant is 8.74.

9. The lithium ion battery according to claim 8, wherein the dispersant comprises a mixture of lithium carboxymethylcellulose and sodium carboxymethylcellulose.

10. The lithium ion battery according to claim 8, wherein the dispersant has a degree of substitution ranging from 0.6 to 1.3.

11. The lithium ion battery according to claim 8, wherein the negative electrode active material comprises one or a combination of artificial graphite, natural graphite, silicon carbide, mesophase carbon microbeads, silicon, and alloys thereof.

12. The lithium ion battery according to claim 8, wherein the negative electrode active material layer further comprises a binder, and the binder is selected from one or a combination of polyvinylidene fluoride, a copolymer of vinylidene fluoride and hexafluoropropylene, a copolymer of styrene and acrylates, a copolymer of styrene and butadiene, polyamide, polyacrylonitrile, polyacrylates, polyacrylic acid, polyacrylate, sodium carboxymethylcellulose, polyvinylpyrrolidone, polyvinyl ether, polymethylmethacrylate, polytetrafluoroethylene and polyhexafluoropropylene.

13. The lithium ion battery according to claim 8, wherein the negative electrode active material layer further comprises a conductive agent, and the conductive agent comprises one or a combination of conductive carbon, conductive carbon black, lamellar graphite, carbon fiber, carbon nanotube, graphene.

14. The lithium ion battery according to claim 8, wherein the negative electrode current collector comprises one or a combination of copper foil, nickel foil, and carbon-based current collector.

15. The lithium ion battery according to claim 8, wherein the positive electrode comprises a positive electrode active material, and the positive electrode active material comprises one or a combination of lithium cobalt oxide, lithium manganese oxide, lithium nickel manganese oxide, lithium nickel cobalt manganese oxide, lithium iron phosphate, lithium nickel cobalt aluminate, lithium nickel cobalt oxide, and lithium nickel oxide.

16. The lithium ion battery according to claim 8, wherein the electrolyte comprises a lithium salt and a solvent, and the lithium salt is selected from one or a combination of lithium hexafluorophosphate (LiPF₆), lithium difluorophosphate (LiPO₂F₂), lithium tetrafluoroborate (LiBF₄), lithium hexafluoroarsenate, lithium perchlorate, lithium dioxalate borate (LiBOB), lithium difluorooxalate borate (LiDFOB), lithium bisfluorosulfonimide (LiFSI), lithium bis-trifluoromethane sulfonimide (LiTFSI); the solvent comprises one or a combination selected from ethylene carbonate, propylene carbonate, butylene carbonate, ethyl methyl carbonate, dimethyl carbonate, diethyl carbonate, dipropyl carbonate, methyl propyl carbonate, ethyl propyl carbonate, 1,4-butyrolactone, methyl propionate, methyl butyrate, ethyl acetate, ethyl propionate, ethyl butyrate.
